(19) United States
(12) Patent Application Publication
(10) Pub. No.: US 2026/0312211 A1
(43) Pub. Date: Oct. 8, 2026

(54) BATTERY PACK AND PACK CASE

(71) Applicant: LG Energy Solution, Ltd., Seoul (KR)

(72) Inventors: Jae-Yong UHM, Daejeon (KR); Ji-Seon MUN, Daejeon (KR); Hong-Se SON, Daejeon (KR); Ki-Taek JUNG, Daejeon (KR); Wan-Sup CHOI, Daejeon (KR)

(21) Appl. No.: 19/637,901

(22) Filed: Apr. 2, 2026

(30) Foreign Application Priority Data
Apr. 3, 2025 (KR) 10-2025-0043516
Mar. 5, 2026 (KR) 10-2026-0039945

(51) Int. Cl. H01M 50/271; B60L 50/64; H01M 10/658; H01M 50/204; H01M 50/249; H01M 50/30

(52) U.S. Cl. CPC H01M 50/271; B60L 50/64; H01M 10/658; H01M 50/204; H01M 50/249; H01M 50/394; H01M 2220/20

(57) ABSTRACT

A battery pack includes a bottom cover assembly including an upper plate and a lower plate spaced downward from the upper plate, a sidewall provided on the bottom cover assembly, and a battery cell positioned above the bottom cover assembly, and the lower plate includes a slide part that becomes closer to the upper plate as a distance from the sidewall increases.

### CROSS-REFERENCE TO RELATED APPLICATIONS

This application is based on and claims priority from Korean Patent Application No. 10-2025-0043516 filed on Apr. 3, 2025, with the Korean Intellectual Property Office, and Korean Patent Application No. 10-2026-0039945, filed on Mar. 5, 2026, with the Korean Intellectual Property Office, the disclosures of which are incorporated herein in their entirety by reference.

### TECHNICAL FIELD

The present disclosure relates to a battery pack and a pack case.

### BACKGROUND

As the demand for portable electronic products such as smartphones, tablet PCs, and smartwatches has increased significantly, and electric vehicles have become increasingly widespread, research on the batteries incorporated therein, particularly, on the secondary batteries capable of repeatedly charging and discharging, is actively being conducted.

Commercialized secondary batteries in the present include nickel cadmium batteries, nickel hydride batteries, nickel zinc batteries, and lithium secondary batteries. Among the secondary batteries, the lithium secondary batteries have attracted significant attention due to their advantages over the nickel-based secondary batteries, such as little memory effect, which allows a flexible charging and discharging, a very low self-discharge rate, and a high energy density.

The lithium secondary batteries generally use lithium-based oxides and carbon materials as a positive electrode active material and a negative electrode active material, respectively. Such a lithium secondary battery includes an electrode assembly in which a positive electrode plate and a negative electrode plate, which are coated respectively with the positive electrode active material and the negative electrode active material, are arranged with a separator interposed therebetween, and an exterior material, that is, a battery case, which hermetically accommodates the electrode assembly along with an electrolyte.

In general, the lithium secondary batteries may be classified, according to the shape of the exterior material, into can-type secondary batteries in which the electrode assembly is accommodated in a metallic can, and pouch-type secondary batteries in which the electrode assembly is accommodated in a pouch formed of an aluminum laminate sheet.

Recently, secondary batteries have been widely used for driving or energy storage not only in small-sized devices such as portable electronic devices but also in medium- to large-sized devices such as electric vehicles and energy storage systems (ESS). Such secondary batteries may be accommodated together in the inside of a module case in a state where a plurality of secondary batteries are electrically connected, thereby constituting a single battery module. In this case, each of the secondary batteries included in a single battery module may be referred to as a battery cell. Then, a plurality of such battery modules may be connected to constitute a single battery pack.

However, when a battery pack includes a plurality of battery modules and each battery module includes a plurality of battery cells as described above, the battery pack may be vulnerable to a thermal chain reaction between battery modules or between battery cells. For example, when an event such as thermal runaway occurs in the inside of one battery module, it is necessary to prevent propagation of thermal runaway to other battery modules or other battery cells. When propagation of thermal runaway between battery modules or between battery cells is not properly prevented, an event occurring in a specific battery module or battery cell may induce a chain thermal reaction in other battery modules or other battery cells, thereby causing an explosion or fire, or increasing the scale of the explosion or fire.

When an event such as a thermal runaway occurs in a battery module, gas or flame may be randomly discharged to the outside. In this case, when the discharge of the gas or flame is not properly controlled, the gas or flame may be discharged toward other battery modules, thereby causing a thermal chain reaction in the other battery modules. In particular, the front side of the battery module may be provided with a module terminal and a configuration for electrical connection with another battery module or a battery pack, such as a module busbar. Accordingly, when the flame is discharged toward the front side of the battery module, the module terminal may be damaged and an electrical short may occur within the battery pack. Furthermore, since another battery module may be disposed on the front side of the battery module, when the flame is discharged toward the front side of a specific battery module, the discharged flame may be directed toward the another battery module, thereby facilitating a fire propagation between the battery modules.

When a thermal propagation between battery modules or between battery cells is not properly controlled, a rapid voltage drop may occur in the battery module or the battery pack. Then, this may cause an abrupt shutdown of a device in which the battery module or the battery pack is mounted, resulting in an unexpected damage. For example, when a sudden voltage drop of the battery pack occurs while an electric vehicle is being driven, it may be impossible to secure sufficient time to move the electric vehicle to a safe location.

Moreover, when a fire or explosion suddenly occurs due to the failure to properly control thermal propagation between battery modules or between battery cells, there is a high possibility of causing personal injury to users. For example, when an event such as thermal runaway occurs in an electric vehicle, the occupants in the vehicle may not be able to escape safely when a sufficient time is not secured before the event develops into a full-scale fire.

### SUMMARY

The present disclosure provides a battery pack and a pack case, which have an improved structure to appropriately control discharge of flame and other combustion byproducts generated in the inside of a battery module, and a vehicle including the same.

The present disclosure provides a structure capable of separating the high-temperature particles from a battery module when a thermal event occurs.

The present disclosure provides a structure capable of preventing the thermal propagation between battery cells or between battery modules.

The present disclosure provides a structure capable of rapidly discharging the venting gas when a thermal event occurs.

However, the technical issues to be addressed by the present disclosure are not limited to those described above, and other issues not mentioned herein will be clearly understood by those skilled in the art from the following description of the present disclosure.

According to one embodiment of the present disclosure, a battery pack includes a bottom cover assembly including an upper plate and a lower plate spaced downward from the upper plate, a sidewall provided on the bottom cover assembly, and a battery cell positioned above the bottom cover assembly, wherein the lower plate may include a slide part that becomes closer to the upper plate as a distance from the sidewall increase.

The slide part may be formed as a planar surface.

The slide part may be formed as a curved surface.

The upper plate may include an inlet hole.

The inlet hole may face the battery cell.

The battery pack may further include a module case that accommodates the battery cell, and the module case may include a venting hole facing the inlet hole.

A gap may be formed between the sidewall and the module case, and the battery pack may further include a heat-insulating member positioned below the gap and provided on a lower surface of the upper plate.

The battery pack may further include a venting device provided to the sidewall.

The venting device may be in communication with a space between the upper plate and the lower plate.

The battery pack may further include a top cover positioned above the battery cell and including an internal flow path therein.

A vehicle according to one aspect of the present disclosure includes the battery pack of the present disclosure.

According to another embodiment of the present disclosure, a battery pack case includes a bottom cover assembly including an upper plate and a lower plate spaced downward from the upper plate, a sidewall provided at an edge of the bottom cover assembly, and a top cover assembly coupled to the sidewall, wherein the lower plate of the bottom cover assembly includes a slide part that forms an inclined surface with respect to a plane and becomes closer to the upper plate as a distance from the sidewall toward a central portion of the lower plate increase.

An angle between the inclined surface of the slide part and the plane is about 30° or greater.

According to at least one of the embodiments of the present disclosure, the high-temperature particles may flow in a direction away from the battery module when a thermal event occurs.

According to at least one of the embodiments of the present disclosure, the thermal propagation between battery cells or between battery modules may be suppressed.

According to at least one of the embodiments of the present disclosure, the thermal safety of a battery pack may be improved.

According to at least one of the embodiments of the present disclosure, the venting gas may be discharged rapidly when a thermal event occurs.

According to at least one of the embodiments of the present disclosure, an electrical safety of a battery pack may be improved.

### BRIEF DESCRIPTION OF THE DRAWINGS

The following drawings attached hereto illustrate embodiments of the present disclosure and serve to further understand the technical idea of the present disclosure together with the content of the disclosure described above. Therefore, the present disclosure should not be construed as being limited to the matters illustrated in the drawings.

FIG. 1 is a diagram illustrating a battery pack, according to one embodiment of the present disclosure.

FIG. 2 is an exploded view illustrating a partial configuration of the battery pack of FIG. 1.

FIG. 3 is a diagram illustrating a top cover assembly of FIG. 2.

FIG. 4 is an exploded view illustrating a partial configuration of the top cover assembly of FIG. 3.

FIG. 5 is a diagram illustrating a battery module of FIG. 2.

FIG. 6 is an exploded view illustrating a partial configuration of the battery module of FIG. 5.

FIG. 7 is a diagram illustrating a bottom cover assembly of FIG. 2.

FIG. 8 is an exploded view illustrating a partial configuration of the bottom cover assembly of FIG. 7.

FIG. 9 is a cross-sectional view taken along the line C-C' of FIG. 1.

FIG. 10 is a cross-sectional view taken along the line D-D' of FIG. 1.

FIG. 11 is a cross-sectional view taken along the line A-A' of FIG. 1.

FIG. 12 is a cross-sectional view taken along the line B-B' of FIG. 1.

FIG. 13 is an enlarged view of portion E of FIG. 12.

FIG. 14 is a diagram illustrating movement of particles in FIG. 13.

FIG. 15 is a diagram illustrating a modification of FIG. 8.

FIG. 16 is a diagram illustrating a modification of FIG. 14.

FIG. 17 is a diagram illustrating movement of particles when a thermal event occurs.

FIG. 18 is a diagram illustrating a vehicle, according to one aspect of the present disclosure.

In some of the accompanying drawings, corresponding components will be denoted with the same reference numerals. The drawing figures presented are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

Hereinafter, embodiments of the present disclosure will be described in detail with reference to the accompanying drawings. Words and terms used in the detailed description and the claims herein should not be interpreted to be limited to their usual or dictionary meanings, but should be interpreted to have meanings and concepts that correspond to the technical idea of the present disclosure in compliance with the principle that inventors may appropriately define terms and concepts for the purpose of best describing the present disclosure.

Accordingly, it can be appreciated that the embodiments described herein and the configurations illustrated in the drawings are merely the most preferable embodiments of the present disclosure, which do not exhaustively represent the technical idea of the present disclosure, and various equivalents and modifications may be made to substitute the present disclosure at the time of filing the present disclosure.

One embodiment of the present disclosure provides a battery pack and a pack case, in which, when a thermal event occurs, the high-temperature particles may flow in a direction away from a battery module, thereby suppressing the thermal propagation between the battery cells or between the battery modules and achieving an improved thermal safety.

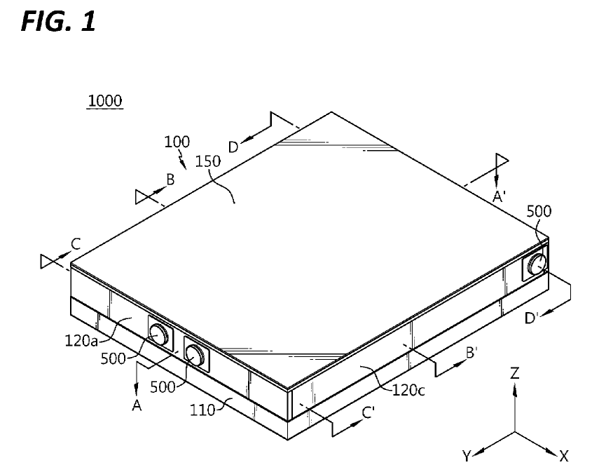

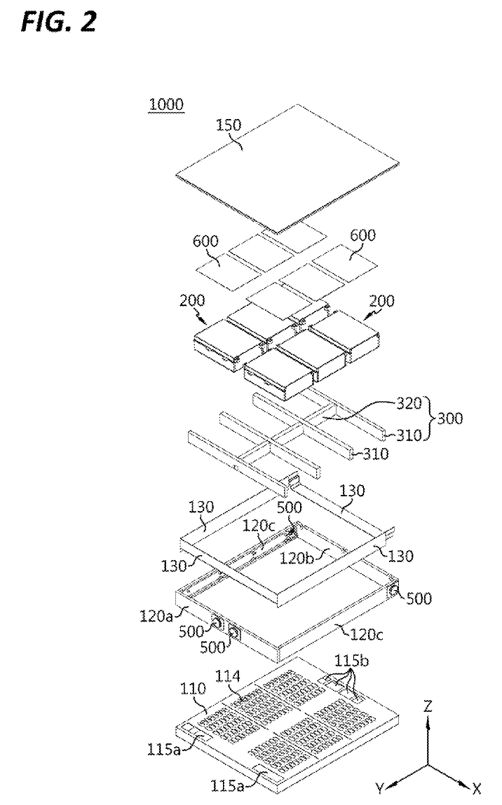

FIG. 1 is a diagram illustrating a battery pack 1000, according to one embodiment of the present disclosure. FIG. 2 is an exploded view illustrating a partial configuration of the battery pack 1000 of FIG. 1.

Referring to FIGS. 1 and 2, a pack case 100 may provide an internal space therein. The pack case 100 may include a bottom cover assembly 110. The bottom cover assembly 110 may have various shape such as, for example, a rectangular shape or a flat plate shape. The bottom cover assembly 110 may define the exterior appearance of the battery pack 1000 and the internal space of the battery pack 1000.

The pack case 100 may include a first sidewall 120a, which may be installed, fastened, coupled, fixed, or attached to the bottom cover assembly 110. The first sidewall 120a may define the internal space and the exterior appearance of the battery pack 1000, and may extend in the front-rear direction or the X-axis direction.

The pack case 100 may include a second sidewall 120b which may be installed, fastened, coupled, fixed, or attached to the bottom cover assembly 110. The second sidewall 120b may define the internal space and the exterior appearance of the battery pack 1000, and may extend in the front-rear direction or the X-axis direction. The first sidewall 120a and the second sidewall 120b may face each other.

The pack case 100 may include a third sidewall 120c, which may be installed, fastened, coupled, fixed, or attached to the bottom cover assembly 110. The third sidewall 120c may define the internal space and the exterior appearance of the battery pack 1000, and may extend in the left-right direction or the Y-axis direction. A pair of third sidewalls 120c may be provided to face each other.

The pack case 100 may include a top cover assembly 150 which may have a rectangular plate shape. The top cover assembly 150 may define the exterior appearance of the battery pack 1000. The top cover assembly 150 may be installed, fastened, coupled, fixed, or attached to the first sidewall 120a, the second sidewall 120b, or the third sidewalls 120c. The top cover assembly 150 may cover the internal space of the battery pack 1000.

The battery pack 1000, according to one embodiment of the present disclosure, may include a partition wall 300. A plurality of partition walls 300 may be provided. The partition walls 300 may include a first partition wall 310. The first partition wall 310 may be installed, fastened, fixed, coupled, or attached to an upper surface of the bottom cover assembly 110. The first partition wall 310 may partition the internal space of the battery pack 1000. A battery module 200 may be positioned in the space partitioned by the first partition wall 310. The first partition wall 310 may extend in the front-rear direction or the X-axis direction.

The partition walls 300 may include a second partition wall 320, which may be installed, fastened, fixed, coupled, or attached to the upper surface of the bottom cover assembly 110. The second partition wall 320 may partition the internal space of the battery pack 1000. The battery module 200 may be positioned in the space partitioned by the second partition wall 320. The second partition wall 320 may extend in the left-right direction or the Y-axis direction.

The battery module 200 may be disposed in the inside of the pack case 100, and installed, fastened, fixed, coupled, or attached to the upper surface of the bottom cover assembly 110. A plurality of battery modules 200, for example, 6 battery modules, may be provided. The battery modules 200 may be positioned in the respective spaces partitioned by the partition walls 300.

A first heat transfer member 600 may be provided for each battery module 200 and disposed between the top cover assembly 150 and the battery modules 200. For example, the first heat transfer member 600 may be made of a material having a high thermal conductivity such as, for example, resin.

According to one embodiment, a venting device 500 may be provided in the first sidewall 120a. Alternatively, the venting device 500 may be provided in each of the pair of third sidewalls 120c. In an embodiment, the venting device 500 may be a gas valve. The venting device 500 may be opened to discharge gas when the internal pressure of the pack case 100 increases. Further, the venting device 500 may block the external air from flowing into the inside of the pack case 100. A plurality of venting devices 500 may be provided.

A plurality of inner walls 130 may be provided. An inner wall 130 may be fastened, coupled, attached, fixed, or installed on an inner surface of the first sidewall 120a. A flow path may be formed between the inner wall 130 and the first sidewall 120a. An inner wall 130 may be fastened, coupled, attached, fixed, or installed on an inner surface of the second sidewall 120b. A flow path may be formed between the inner wall 130 and the second sidewall 120b. An inner wall 130 may be fastened, coupled, attached, fixed, or installed on inner surfaces of the third sidewalls 120c. A flow path may be formed between the inner wall 130 and the third sidewall 120c.

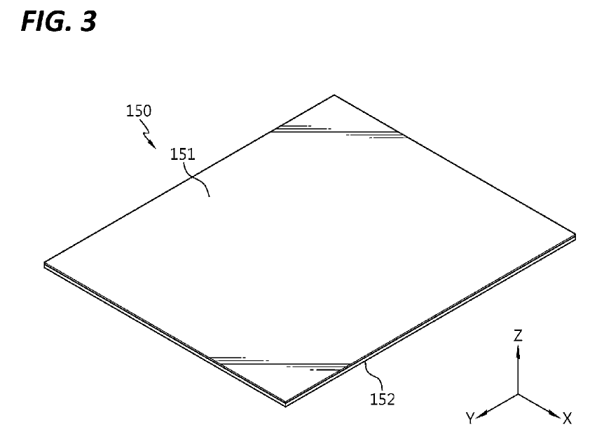

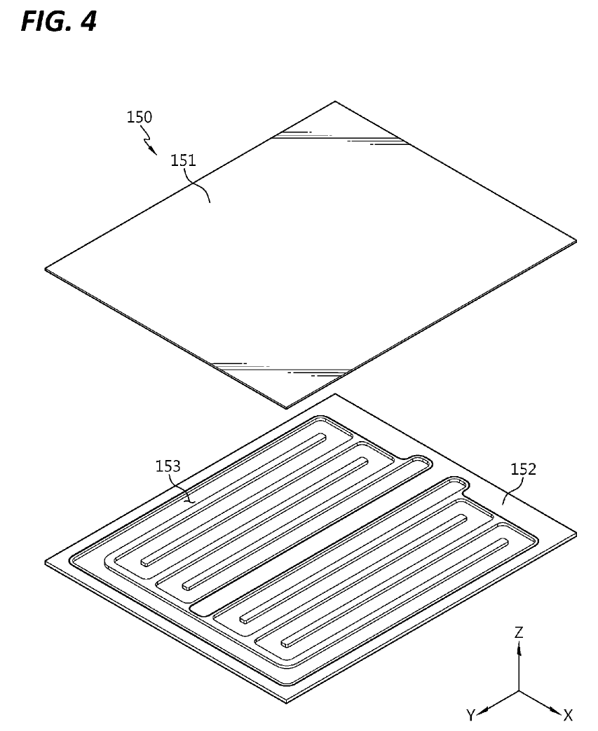

FIG. 3 is a diagram illustrating the top cover assembly 150 of FIG. 2. FIG. 4 is an exploded view illustrating a partial configuration of the top cover assembly 150 of FIG. 3.

Referring to FIGS. 3 and 4, the top cover assembly 150 may include a second upper plate 151 and a second lower plate 152. The second upper plate 151 may have a rectangular shape, and define the exterior appearance of the battery pack 1000. The second lower plate 152 may have a rectangular shape, and define the exterior appearance of the battery pack 1000. The second upper plate 151 may be disposed above the second lower plate 152. According to one embodiment, the top cover assembly 150 may include an internal cooling flow path 153 therein. For example, the cooling flow path 153 may be disposed between the second upper plate 151 and the second lower plate 152.

The inside of the cooling flow path 153 may be filled with a cooling liquid such as, for example, water, which may flow along the cooling flow path 153.

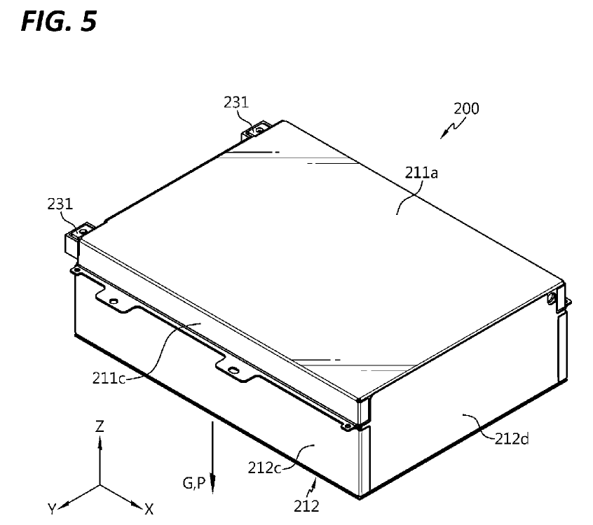

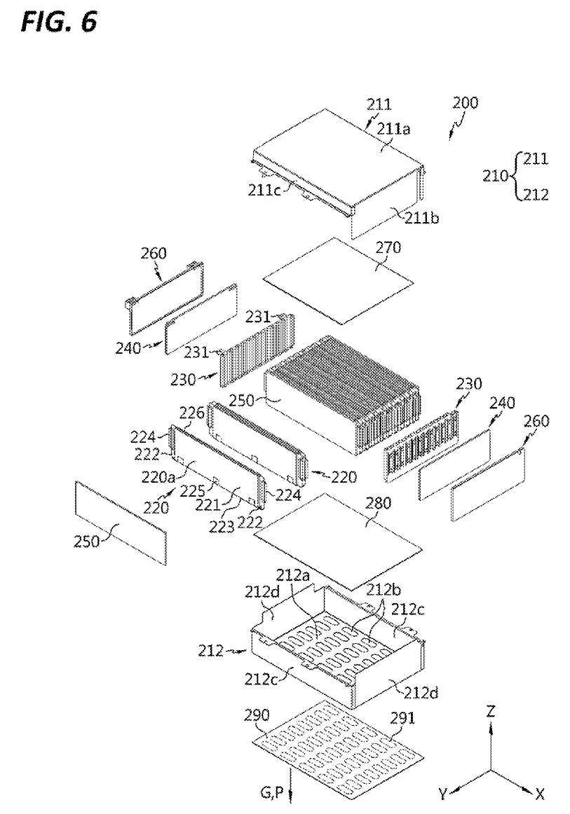

FIG. 5 is a diagram illustrating the battery module 200 of FIG. 2. FIG. 6 is an exploded view illustrating a partial configuration of the battery module 200 of FIG. 5.

Referring to FIGS. 5 and 6, a module case 210 may have a rectangular parallelepiped shape, and define the exterior appearance of the battery module 200. The module case 210 may provide an internal space therein, and include an upper frame 211 and a lower frame 212.

The upper frame 211 may include a top plate 211a and a first side plate 211c. A pair of first side plates 211c may be provided. The first side plates 211c may be provided on the left and right sides of the top plate 211a, respectively, and extend downward from the top plate 211a.

The upper frame 211 may include a first end plate 211b. A pair of first end plates 211b may be provided. The first end plates 211b may be provided on the front and rear sides of the top plate 211a, respectively, and extend downward from the top plate 211a.

The lower frame 212 may include a bottom plate 212a which may have a venting hole 212b. The venting hole 212b may extend in the front-rear direction or the X-axis direction. A plurality of venting holes 212b may be provided, and arranged in the front-rear direction or the X-axis direction. Alternatively, the plurality of venting holes 212b may be arranged in the left-right direction or the Y-axis direction.

The lower frame 212 may include a second side plate 212c. A pair of second side plates 212c may be provided. The second side plates 212c may be provided on the left and right sides of the bottom plate 212a, respectively, and extend upward from the bottom plate 212a.

The lower frame 212 may include a second end plate 212d. A pair of second end plates 212d may be provided. The second end plates 212d may be provided on the front and rear sides of the bottom plate 212a, respectively, and extend upward from the bottom plate 212a.

The upper frame 211 and the lower frame 212 may be coupled, fastened, attached, or assembled to each other. The first side plates 211c may be coupled, fastened, attached, or assembled with the second side plates 212c. The first end plates 211b may be positioned inside the second end plates 212d. The top plate 211a and the bottom plate 212a may face each other.

A battery cell 220 may be accommodated in the inside of the module case 210. A plurality of battery cells 220 may be provided. The battery cells 220 may refer to secondary batteries. For example, the battery cells 220 may be pouch-type secondary batteries. However, the shape of the battery cells 220 is not limited to a pouch shape and the battery cells 220 may have various shapes such as a cylindrical shape or a rectangular parallelepiped shape.

The battery cells 220 may extend in the front-rear direction or the X-axis direction. Each battery cell 220 may include a cell case 220a providing an internal space therein. The cell case 220a may include an accommodating portion 221 accommodating an electrode assembly, first sealing portions 222 respectively protruding from the front and rear sides of the accommodating portion 221, and a second sealing portion 223 protruding downward from the accommodating portion 221. The first sealing portions 222 and the second sealing portion 223 may be formed by bonding or attaching the cell case 220a. An upper end of the accommodating portion 221 may be referred to as a folding portion 226. The folding portion 226 may be formed by folding the cell case 220a. Further, the battery cell 220 may include electrode leads 224 respectively protruding forward and rearward from the first sealing portions 222. The electrode leads 224 may protrude forward and rearward of each battery cell 220. The plurality of battery cells 220 may be stacked in the left-right direction or the Y-axis direction. Each battery cell 220 may include an adhesive member 225 configured to fold and fix the second sealing portion 223 to the accommodating portion 221. The adhesive member 225 may allow the second sealing portion 223 to come into close contact with the accommodating portion 221. A plurality of adhesive members 225 may be provided. The plurality of adhesive members 225 may be arranged in the front-rear direction or the X-axis direction.

Barriers 250 may be disposed between the plurality of battery cells 220. The barriers 250 may be disposed between at least some of the battery cells 220 and/or at the outer periphery of a stack of the battery cells 220. For example, the barriers 250 may be configured such that one barrier is disposed between every three battery cells 220 stacked in the left-right direction.

The barriers 250 may be made of an elastic material capable of absorbing swelling of the battery cells 220. For example, the barriers 250 may be made of a foam material such as polyurethane. Alternatively, the barriers 250 may be made of a material capable of blocking, for example, heat or flame. For example, the barriers 250 may be made of a heat-insulating or fire-resistant material such as silicone or mica.

Busbar frame assemblies 230 may be provided on the front and rear sides of the plurality of battery cells 220, respectively. The front busbar frame assembly 230 may be electrically connected to the front-side electrode leads 224 of the plurality of battery cells 220. The rear busbar frame assembly 230 may be electrically connected to the rear-side electrode leads 224 of the plurality of battery cells 220. According to one embodiment, the rear busbar frame assembly 230 may include a power terminal 231.

Heat-insulating covers 240 may be provided outside the respective busbar frame assemblies 230. The heat-insulating covers 240 may be provided on the rear busbar frame assembly 230 and the front busbar frame assembly 230, respectively. The heat-insulating covers 240 may be made of a material capable of blocking, for example, heat or flame. For example, the heat-insulating covers 240 may be made of a heat-insulating or fire-resistant material such as silicone or mica.

Electrical-insulating covers 260 may be provided outside the respective heat-insulating covers 240. The electrical-insulating covers 260 may be provided on the rear heat-insulating cover 240 and the front heat-insulating cover 240, respectively. The electrical-insulating covers 260 may include a material having electrical insulating properties. An electrical-insulating cover 260 may be disposed between the rear heat-insulating cover 240 and the first end plate 211b. Alternatively, an electrical-insulating cover 260 may be disposed between the front heat-insulating cover 240 and the first end plate 211b.

A second heat transfer member 270 may be disposed between the top plate 211a and the plurality of battery cells 220. For example, the second heat transfer member 270 may be made of a material having high thermal conductivity such as, for example, resin.

An inner venting cover 280 may be disposed between the bottom plate 212a and the plurality of battery cells 220. The inner venting cover 280 may have a sheet shape and cover the venting holes 212b. The inner venting cover 280 may be fastened, coupled, attached, fixed, or assembled to an upper surface of the bottom plate 212a.

An outer venting cover 290 may be fastened, coupled, attached, fixed, or assembled to a lower surface of the bottom plate 212a. The outer venting cover 290 may have a sheet shape and cover the venting holes 212b. The outer venting cover 290 may include a separation line 291, which may be used as a generic term including a perforated line 291, a notching line 291, a cutting line 291, a shredding line 291, a tear line 291, or a score line 291. The separation line 291 may be configured to be easily separated by pressure applied to the outer venting cover 290.

According to one embodiment, when a thermal event occurs in the inside of the battery module 200, the inner venting cover 280 and the outer venting cover 290 may rupture, and the venting holes 212b may be opened. The venting gas G and particles P may be discharged downward, for example, through the venting holes 212b, or in the negative Z-axis direction.

Further, the inner venting cover 280 and the outer venting cover 290 may block venting the gas G and particles P generated outside the battery module 200 from entering the inside of the battery module 200.

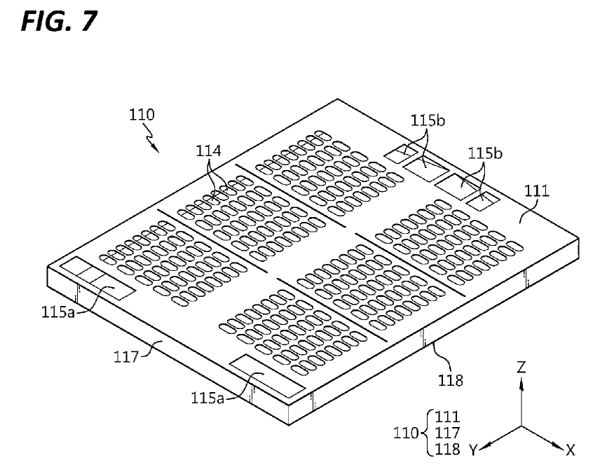

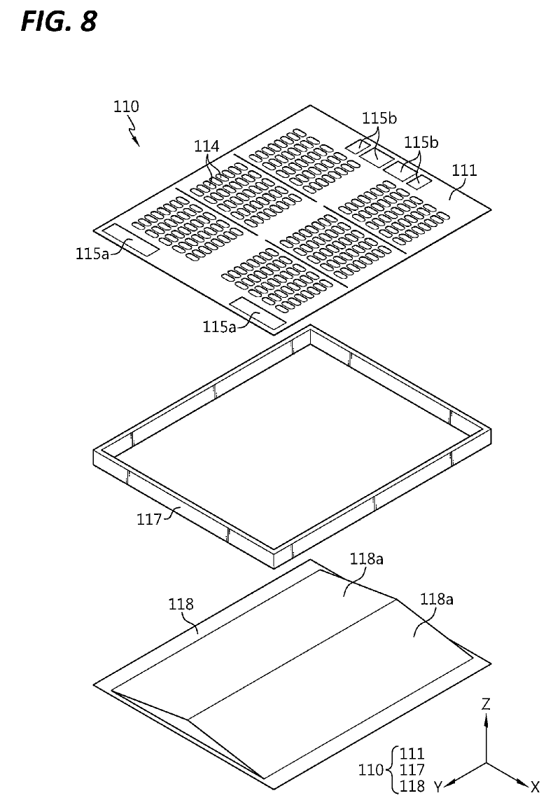

FIG. 7 is a diagram illustrating the bottom cover assembly 110 of the pack case 100 of FIG. 2. FIG. 8 is an exploded view illustrating a partial configuration of the bottom cover assembly 110 of FIG. 7.

Referring to FIGS. 7 and 8, the bottom cover assembly 110 may include a first upper plate 111 and a first lower plate 118. The first upper plate 111 may have a rectangular shape, and define the exterior appearance of the battery pack 1000. The first lower plate 118 may have a rectangular shape, and define the exterior appearance of the battery pack 1000. The first upper plate 111 may be disposed above the first lower plate 118.

The bottom cover assembly 110 may include a spacer 117, which may be disposed between the first upper plate 111 and the first lower plate 118. The first upper plate 111 and the first lower plate 118 may be spaced apart from each other by the spacer 117. The spacer 117 may be fastened, coupled, connected, assembled, installed, attached, or fixed to the first upper plate 111. Alternatively, the spacer 117 may be fastened, coupled, connected, assembled, installed, attached, or fixed to the first lower plate 118.

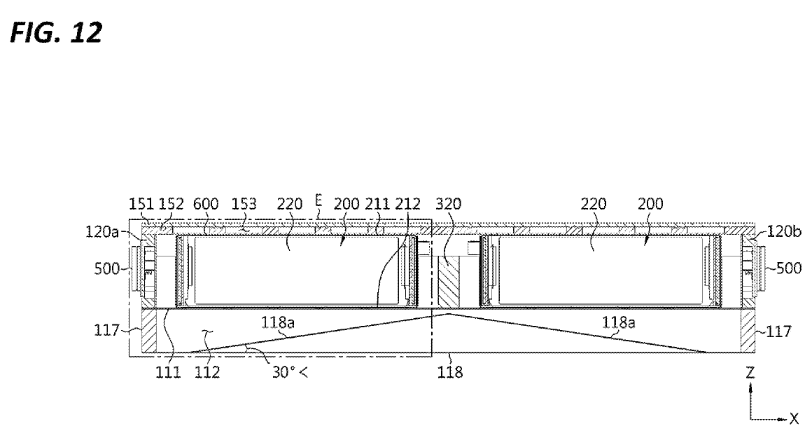

The bottom cover assembly 110 may include a venting space 112 in the inside thereof. The venting space 112 may be defined between the first upper plate 111 and the first lower plate 118 (see, e.g., FIG. 12). The spacer 117 may define the venting space 112. The first upper plate 111 may have an inlet hole 114. The inlet hole 114 of the first upper plate 111 may be in communication with the venting space 112 therebelow. The inlet hole 114 of the first upper plate 111 may face the outer venting cover 290 and the separation line 291 of the module case 210.

When a thermal event occurs, the inlet hole 114 of the first upper plate 111 may face and communicate with the venting holes 212b formed in the bottom plate 211a of the module case 210.

A plurality of inlet holes 114 may be provided in the first upper plate 111. According to one embodiment, the inlet holes 114 may be provided respectively for each venting hole 212b formed in the bottom plate 211a of the module case 210. The plurality of inlet holes 114 may be arranged in the left-right direction or the X-axis direction. The plurality of inlet holes 114 may be arranged in the front-rear direction or the Y-axis direction. The venting gas G and the particles P discharged through the inlet holes 114 may flow through the venting space 112.

Referring to FIG. 8, the first lower plate 118 of the bottom cover assembly 110 according to one embodiment of the present disclosure may protrude upward. For example, the central portion of the first lower plate 118 of the bottom cover assembly 110 may protrude toward the first upper plate 111. Further, according to one embodiment, the first lower plate 118 may include a slide part 118a formed of an inclined surface. For example, the slide part 118a may be incline toward the central portion of the first upper plate 111.

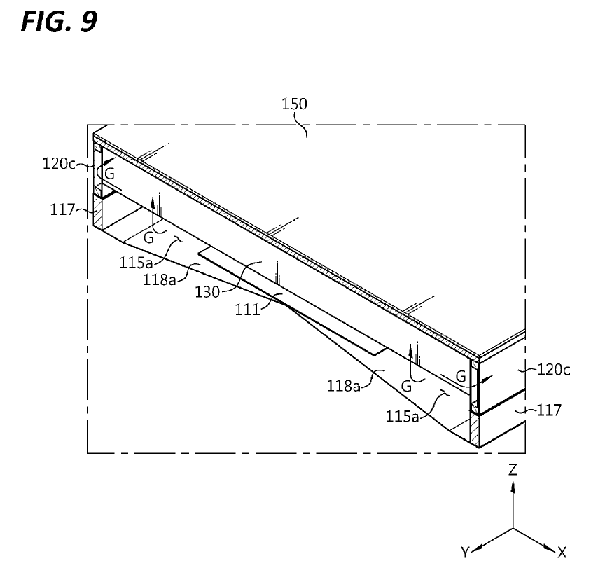

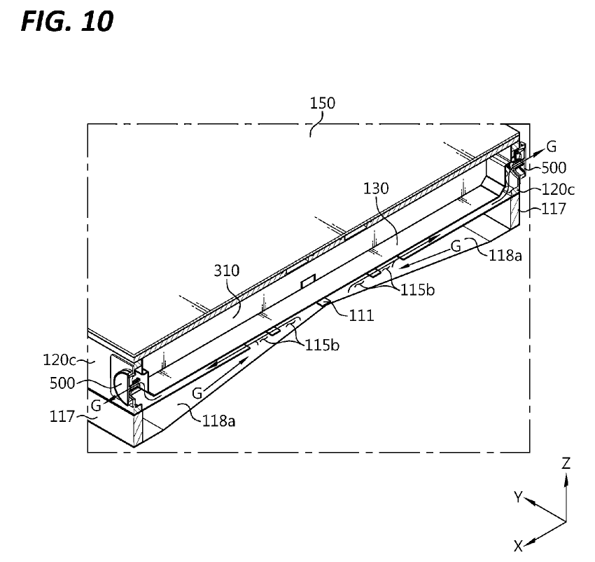

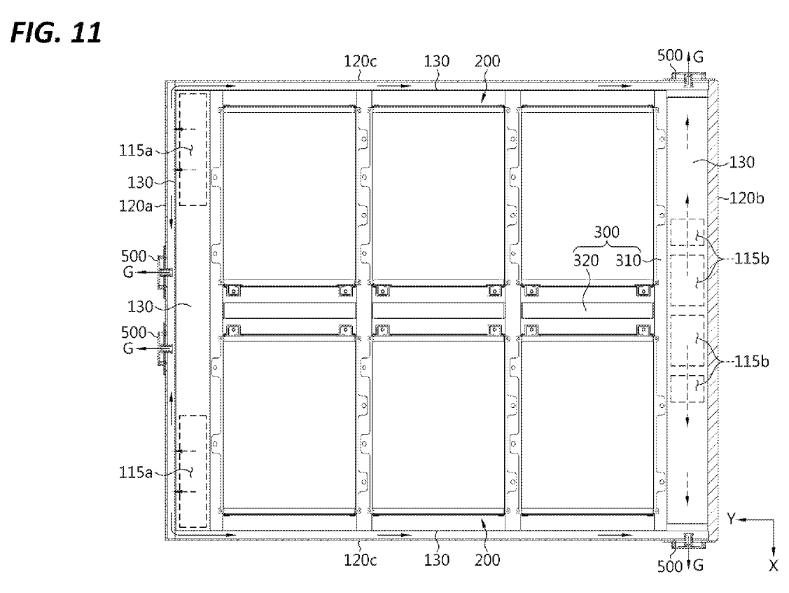

FIG. 9 is a cross-sectional view taken along the line C-C' of FIG. 1. FIG. 10 is a cross-sectional view taken along the line D-D' of FIG. 1. FIG. 11 is a cross-sectional view taken along the line A-A' of FIG. 1.

Referring to FIGS. 9 and 11, the first upper plate 111 of the bottom cover assembly 110 included in the pack case 100 may include a first discharge hole 115a. The first discharge hole 115a may be in communication with the venting space 112 (see, e.g., FIG. 12). The first discharge hole 115a may be in communication with a space between the first upper plate 111 and the first lower plate 118. The first discharge hole 115a may be in communication with a space between the first sidewall 120a and the inner wall 130. The first discharge hole 115a may be in communication with the venting device 500. The first discharge hole 115a may be in communication with a space between the third sidewall 120c and the inner wall 130. A plurality of first discharge holes 115a may be provided. The venting gas G may be discharged to the outside of the battery pack 1000 through the first discharge holes 115a and the venting device 500 installed to the first sidewall 120a.

Referring to FIGS. 10 and 11, the first upper plate 111 of the bottom cover assembly 110 included in the pack case 100 may include a second discharge hole 115b. The second discharge hole 115b may be in communication with the venting space 112. The second discharge hole 115b may be in communication with a space between the first upper plate 111 and the first lower plate 118. The second discharge hole 115b may be in communication with a space between the third sidewall 120c and the inner wall 130. The second discharge hole 115b may be in communication with the venting device 500. A plurality of second discharge holes 115b may be provided. The venting gas G may be discharged to the outside of the battery pack 1000 through the second discharge holes 115b and the venting device 500 installed to the third sidewall 120c.

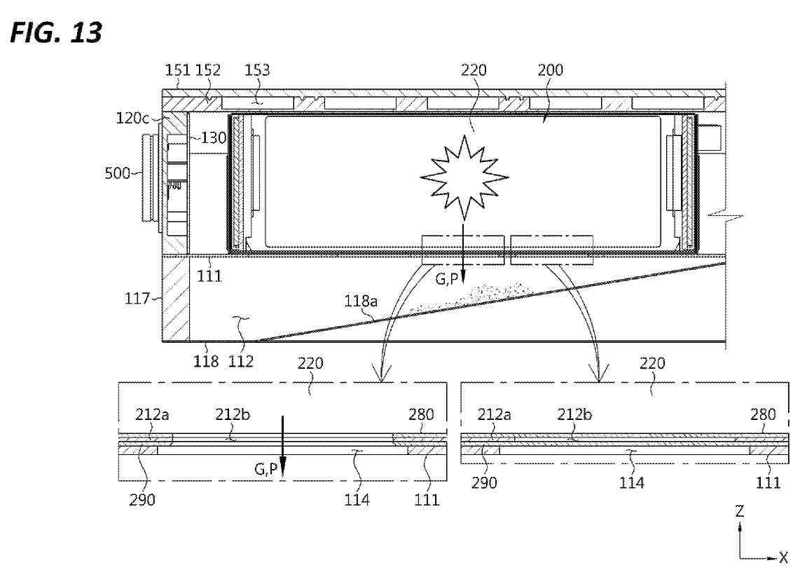

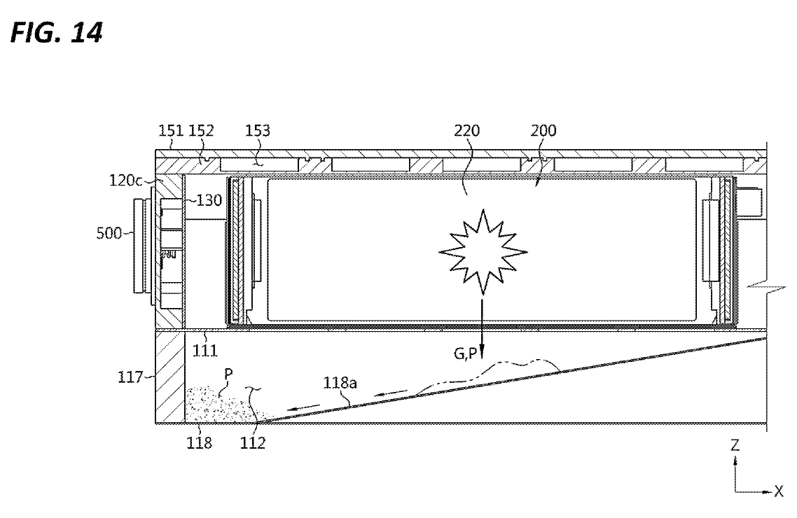

FIG. 12 is a cross-sectional view taken along the line B-B' of FIG. 1. FIG. 13 is an enlarged view of portion E of FIG. 12. FIG. 14 is a diagram illustrating movement of the particles P in FIG. 13.

Referring to FIGS. 12 to 14, the battery cell 220 may be positioned above the bottom cover assembly 110 of the pack case 100. According to one embodiment of the present disclosure, the first lower plate 118 of the bottom cover assembly 110 may include the slide part 118a that becomes closer to the first upper plate 111 as a distance from the third sidewall 120c increases. For example, the slide part 118a may form an inclined surface toward the central portion of the first upper plate 111 and may become closer to the first upper plate 111 with a decreasing distance to the central portion. The slide part 118a may be formed as a planar surface or a curved surface. The slide part 118a may be inclined with respect to the first upper plate 111. Meanwhile, the angle of the inclined surface may be determined according to various factors such as the material of the first lower plate 118. According to one embodiment, when an angle formed between the inclined surface and a horizontal plane is about 30° or greater, the flow of the particles P may become smooth. However, the angle is not limited thereto, and may be smaller or larger according to various factors such as the material of the first lower plate 118.

The heat generated from the battery cell 220 may exchange the heat with the cooling liquid provided in the cooling flow path 153 of the top cover assembly 150 through the second heat transfer member 270 and the top plate 211a of the battery module 200, and through the first heat transfer member 600 of the battery pack 1000.

When a thermal event occurs in the battery cell 220, the inner venting cover 280 and the outer venting cover 290 of the battery module 200 may rupture, and the venting holes 212b of the battery module 200 may be in communication with the inlet holes 114 of the bottom cover assembly 110. When a thermal event occurs in the battery cell 220, the inlet holes 114 may face the battery cell 220. The venting gas G and the particles P may be discharged downward. The venting gas G and the particles P may be introduced into the venting space 112 through the inlet holes 114 of the bottom cover assembly 110.

The venting gas G may flow through the venting space 112. The venting gas G may be discharged to the outside of the battery pack 1000 through the first discharge holes 115a or the second discharge holes 115b of the bottom cover assembly 110.

The particles P generated when a thermal event occurs may flow along the slide part 118a of the first lower plate 118. The particles P may flow toward the third sidewalls 120c by gravity. The particles P may flow in the -X direction or +X-axis direction by gravity.

The particles P generated when a thermal event occurs may have a high temperature. When the slide part 118a is not provided, the particles P may not flow and may instead accumulate, resulting in propagation of a thermal event due to the accumulated particles P.

In contrast, according to one embodiment of the present disclosure, the high-temperature particles P may flow along the slide part 118a of the first lower plate 118, thereby increasing the distance between the particles P and the battery module 200. The particles P may flow in one direction along the slide part 118a and may accumulate below a gap between the third sidewall 120c and the battery module 200. As the particles P accumulate below the gap between the third sidewall 120c and the battery module 200, there is a high probability that no battery cell 220 or battery module 200 is located immediately above the particles P, thereby minimizing an influence of the particles P on the battery module 200. For these reasons, as the high-temperature particles P flow along the slide part 118a, propagation of a thermal event due to the particles P may be blocked. Accordingly, thermal stability of the battery pack 1000 may be improved.

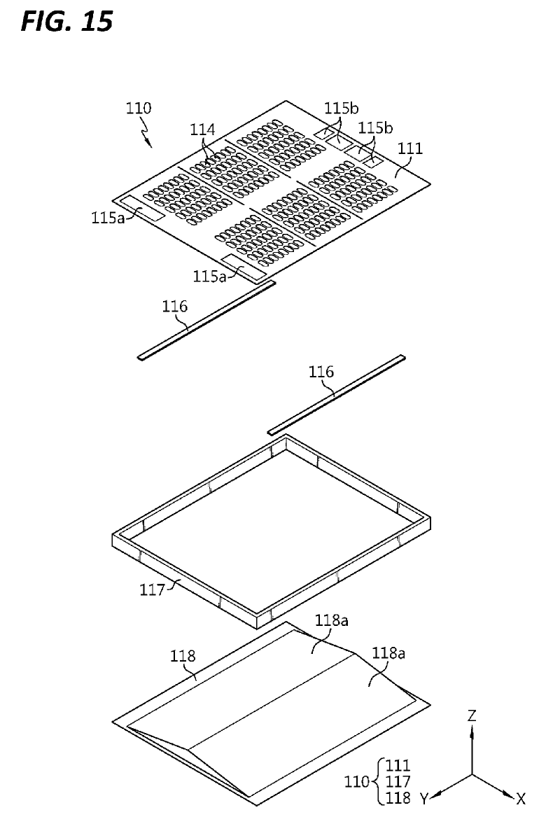

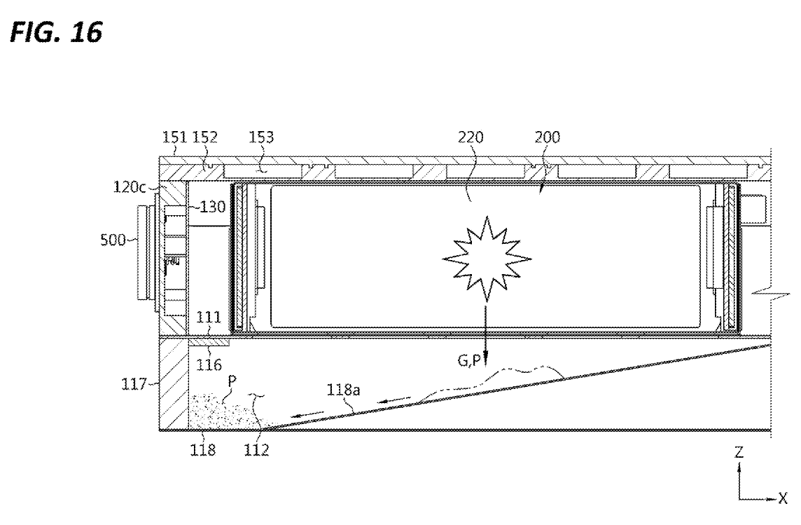

FIG. 15 is a diagram illustrating a modification of FIG. 8. FIG. 16 is a diagram illustrating a modification of FIG. 14.

Referring to FIGS. 15 and 16, a heat-insulating member 116 may be installed, coupled, fastened, connected, fixed, or attached to a lower surface of the first upper plate 111 of the bottom cover assembly 110. The heat-insulating member 116 may be elongated in the left-right direction or the Y-axis direction. The heat-insulating member 116 may be disposed below the gap between the third sidewall 120c and the battery module 200. A pair of heat-insulating members 116 may be provided, and may be made of a material capable of blocking, for example, heat or flames. For example, the heat-insulating members 116 may be made of a heat-insulating or fire-resistant material such as silicone or mica.

When a thermal event occurs, the particles P generated from the battery cell 220 or the battery module 200 may accumulate below the heat-insulating members 116. The heat-insulating members 116 may block upward heat transfer from the accumulated high-temperature particles P. Accordingly, thermal stability of the battery pack 1000 may be improved.

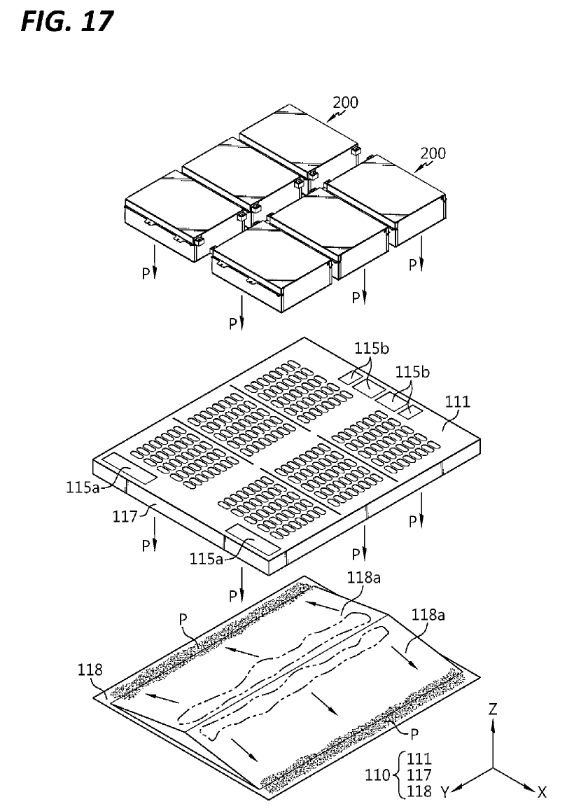

FIG. 17 is a diagram illustrating movement of the particles P when a thermal event occurs.

Referring to FIG. 17, the particles P may be discharged downward when a thermal event occurs. The particles P generated from the battery cell 220 or the battery module 200 may move toward the lower side of the battery pack 1000 and flow toward the third sidewall 120c along the slide part 118a, which is an inclined surface formed on the first lower plate 118. The particles P may flow in a direction away from the venting holes 212b of the battery module 200 or the battery cell 220. Accordingly, propagation of a thermal event due to the particles P may be blocked, and thermal stability may be improved.

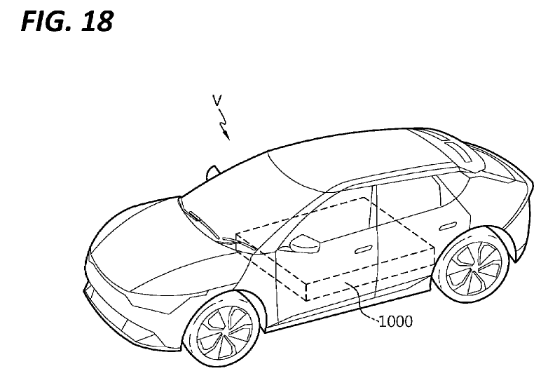

FIG. 18 is a diagram illustrating a vehicle V according to one aspect of the present disclosure.

Referring to FIG. 18, the battery pack 1000 according to the present disclosure may be applied to the vehicle V such as an electric vehicle (EV) or a hybrid vehicle (HEV). For example, the vehicle V according to the present disclosure may include the battery pack 1000 according to one embodiment of the present disclosure. In addition to the battery pack 1000, the vehicle V according to the present disclosure may further include various other components included in vehicles. For example, the vehicle V according to the present invention may further include a vehicle body, a motor, and a control device such as an electronic control unit (ECU).

Meanwhile, in the present specification, terms indicating directions such as upper, lower, left, right, front, and rear are used, but it will be apparent to those skilled in the art that these terms are only for convenience of description and may vary depending on the position of a target object and the position of an observer.

While the present disclosure has been described with reference to the limited embodiments and drawings, the present disclosure is not limited thereto, and various modifications and changes may be made by those skilled in the art of the present disclosure within the technical idea of the present disclosure and the scope equivalent to the claims set forth below.

What is claimed is:

1. A battery pack comprising:
a bottom cover assembly including an upper plate and a lower plate spaced downward from the upper plate;
a sidewall provided on the bottom cover assembly; and
a battery cell positioned above the bottom cover assembly,
wherein the lower plate includes a slide part that becomes closer to the upper plate as a distance from the sidewall increases.

2. The battery pack according to claim 1, wherein the slide part is formed as a planar surface.

3. The battery pack according to claim 1, wherein the slide part is formed as a curved surface.

4. The battery pack according to claim 1, wherein the upper plate includes an inlet hole.

5. The battery pack according to claim 4, wherein the inlet hole faces the battery cell.

6. The battery pack according to claim 4, further comprising a module case configured to accommodate the battery cell,
wherein the module case includes a venting hole facing the inlet hole.

7. The battery pack according to claim 6, wherein a gap is formed between the sidewall and the module case, and
the battery pack further includes a heat-insulating material positioned below the gap and provided on a lower surface of the upper plate.

8. The battery pack according to claim 1, further comprising:
a venting device provided in the sidewall.

9. The battery pack according to claim 8, wherein the venting device is in communication with a space between the upper plate and the lower plate.

10. The battery pack according to claim 1, further comprising:
a top cover positioned above the battery cell and including an internal flow path therein.

11. A vehicle comprising the battery pack according to claim 1.

12. A battery pack case configured to accommodate a battery cell or a battery module, the battery pack case comprising:
a bottom cover assembly including an upper plate and a lower plate spaced downward from the upper plate;
a sidewall provided at an edge of the bottom cover assembly; and
a top cover assembly coupled to the sidewall,
wherein the lower plate of the bottom cover assembly includes a slide part that forms an inclined surface with respect to a plane and becomes closer to the upper plate as a distance from the sidewall toward a central portion of the lower plate increases.

13. The battery pack case according to claim 12, wherein an angle between the inclined surface of the slide part and the plane is about 30° or greater.
